(19) United States
(12) Patent Application Publication
(10) Pub. No.: US 2004/0242079 A1
(43) Pub. Date: Dec. 2, 2004

(54) Block strip for electrical connector blocks

(76) Inventors: Xiankui Shi, Kunsan (CN); Ming Yang, Kunsan (CN); Yi Hung Hsieh, Kunsan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/858,938

(22) Filed: Jun. 1, 2004

(30) Foreign Application Priority Data
May 30, 2003 (TW) 92210046

(51) Int. Cl. H01R 13/44

(52) U.S. Cl. 439/701

(57) ABSTRACT

A block strip (20) for making blocks (22) incorporated in an electrical connector (10) comprises a plurality of blocks for blocking and sealing passageways (12d) defined in a housing (12) of the electrical connector during an insert molding process. Each block has a main body (22a) with a tapered front end (22c) and an enlarged rear end (22b). The front end of one block integrally joins the rear end of a next block to successively form the block strip. With this configuration, successive blocks of the block strip can be used one by one as needed. Every part of the block strip is used, thereby reducing the cost of materials. Additionally, in use, rear blocks of the block strip can be held to facilitate insertion of a frontmost block into a corresponding passageway of the housing. Insertion of the blocks into the passageways is thus speedy and efficient.

### BACKGROUND OF THE INVENTION

1. Field of the Invention

The present invention relates to the art of electrical connectors, and more particularly to a block strip for making blocks that are plugged into an electrical connector prior to insert molding of the connector.

2. Description of the Prior Art

With the trend toward more and more miniaturization of complex electrical connector components, it is becoming increasingly difficult to mold such components precisely and conveniently. One problem is how to extract molding cores from a molded component. In order to solve this problem, access passageways are commonly defined in the component. The passageways provide access to the molding cores, thereby facilitating extraction of the molding cores. However, the component often undergoes a subsequent insert molding process, in order to securely engage the component with one or more mating components. The access passageways must be blocked at this time, in order to prevent molten material from entering an inside of the component. The inside of the component can thus be kept intact.

Referring to FIGS. 6, 7 and 8, a conventional electrical connector 80 comprises a generally box-shaped housing 82, a sealing member 84 mounted on the housing 82, and a plurality of terminals 86 received in the housing 82. An elongate slot 82a is defined in a front of the housing 82, for receiving a mating electrical connector (not shown) having contacts. A pair of protrusions 82b is formed in the front of the housing 82, the protrusions 82b protruding into the slot 82a. The protrusions 82b facilitate engagement between the terminals 86 and the corresponding contacts of the mating connector. The terminals 86 are each received in a corresponding passage 82c defined in the housing 82, with tails 86a thereof exposded outside of the housing 82. With this configuration, after molding of the housing 82, the protrusions 82b render extraction of molding cores of the housing 82 problematic. In order to solve the problem, a pair of access passageways 82d is defined in the housing 82, corresponding to the protrusions 82b. The passageways 82d provide access to and facilitate extraction of the molding cores.

After assembly of the electrical connector 80, the tails 86a of the terminals 86 are soldered onto corresponding wires of an inserted end of a cable (not shown). Then the rear part of the housing 82 and the inserted end of the cable are molded together by an insert molding process, in order to strengthen engagement between the tails 86a of the terminals 86 and the wires.

Before the insert molding process, a pair of blocks 96 is used to seal the passageways 82d, and thereby prevent molten material from entering the slot 82a and the passages 82c of the housing 82. After the insert molding process, the inside of the housing 82 remains intact.

FIG. 9 shows a conventional block strip 90 having an elongate main body 92. A plurality of legs 94 extends extending outwardly from opposite longitudinal sides of the body 92, the legs 94 being parallel to each other and spaced apart from each other a predetermined distance. Each leg 94 has a free end connected with one block 96. With this structure, after all the blocks 96 are extracted, much material of the body 92 and the legs 94 remains and must be recycled or discarded. This inflates the cost of materials. Moreover, it is difficult for a user to hold a single block 96, because it is typically miniaturized. Insertion of the block 96 into a corresponding passageway 82d of the housing 82 is problematic.

What is needed is a block strip for making blocks which overcomes the above-mentioned problems.

### SUMMARY OF THE INVENTION

Accordingly, an object of the present invention is to provide a block strip for making blocks that are plugged into an electrical connector, wherein the block strip is inexpensive and the blocks can be conveniently inserted into the electrical connector.

To fulfill the above-mentioned object, an elongate block strip is applied according to the present invention. The block strip comprises a plurality of blocks for blocking and sealing passageways defined in a dielectric housing of an electrical connector. Each block has a main body with a tapered front end and an enlarged rear end. The front end of one block integrally joins the rear end of a next block, the blocks thereby collectively forming the block strip. With this configuration, successive blocks of the block strip can be used one by one. Every part of the block strip is used, thereby reducing the material cost. Additionally, in use, rear blocks of the block strip can be held to facilitate insertion of a frontmost block into a corresponding passageway of the housing. Speedy and efficient insertion of the blocks of the block strip is thus attained.

Other objects, advantages and novel features of the present invention will become more apparent from the following detailed description when taken in conjunction with the accompanying drawings, in which:

### BRIEF DESCRIPTION OF THE DRAWINGS

FIG. 1 is an isometric view of an electrical connector and a part of a block strip according to the present invention, showing a frontmost block ready to be inserted into a passageway of a housing of the electrical connector;

FIG. 2 is a schematic, cross-sectional view taken along line II-II of FIG. 1, but showing the frontmost block inserted in the passageway of the housing;

FIG. 3 is a side elevation of the block strip, showing all the blocks thereof;

FIG. 4 is an enlarged view of a circled portion IV of FIG. 3;

FIG. 5 is an enlarged view of a single block of the block strip of FIG. 1;

FIG. 6 is an isometric view of a conventional electrical connector, together with a pair of conventional blocks ready to be inserted into corresponding passageways of a housing of the electrical connector;

FIG. 7 is an inverted, isometric view of the housing of FIG. 6;

FIG. 8 is a schematic, cross-sectional view taken along line VIII-VIII of FIG. 6, but showing one block inserted in a corresponding passageway of the housing; and

FIG. 9 is a side elevation of a conventional block strip including blocks such as those of FIG. 6.

### DESCRIPTION OF PREFERRED EMBODIMENT OF THE INVENTION

Reference will now be made to the drawings to describe the present invention in detail.

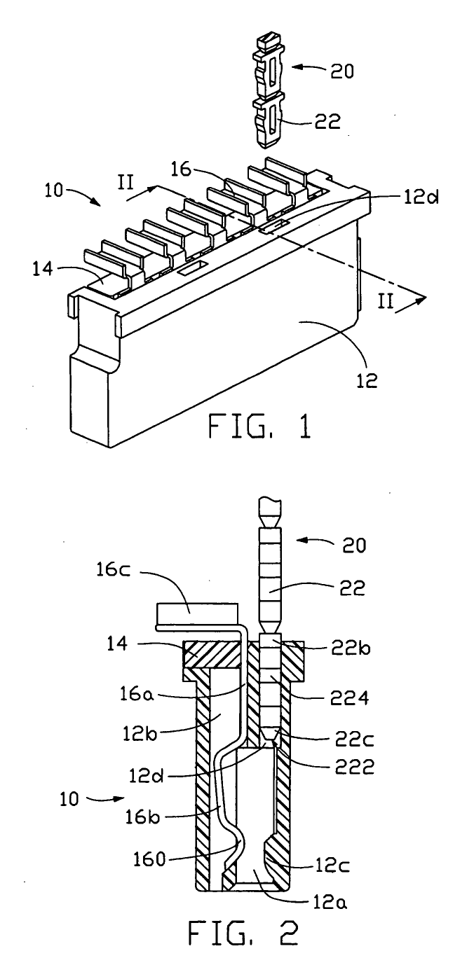

FIG. 1 is an isometric view of an electrical connector 10 and a part of a block strip 20 for making blocks 22 according to the present invention. The electrical connector 10 comprises an elongate generally box-shaped insulative housing 12, a sealing member 14 mounted on the housing 12, and a plurality of conductive terminals 16 received in the housing 12. Referring also to FIG. 2, an elongate slot 12a is defined in a front of the housing 12, for receiving a mating electrical connector (not shown) having a plurality of electrical contacts. A row of passages 12b is defined in a rear of the housing 12 respectively in communication with the slot 12a, the passages 12b receiving the corresponding terminals 16 therein. A pair of protrusions 12c is formed in the front of the housing 12, the protrusions 12c protruding into the slot 12a. The protrusions 12c facilitate engagement between the terminals 16 and the contacts of the mating connector.

With this configuration, after molding of the housing 12, the protrusions 12c render extraction of molding cores of the housing 12 problematic. In order to facilitate such extraction, a pair of access passageways 12d is defined in the housing 12, corresponding to the protrusions 12c. In the preferred embodiment of the present invention, each passageway 12d has a rectangular profile.

Each terminal 16 is formed from conductive metallic material, and comprises a retention portion 16a, an extending portion 16b extending forwardly from one end of the retention portion 16a, and a soldering portion 16c perpendicularly bent from an opposite end of the retention portion 16a. An arcuate contact portion 160 is formed at a free end of the extending portion 16b, for electrically contacting a corresponding contact of the mating electrical connector. The soldering portion 16c forms a generally rectangular recess, for embedding therein of a corresponding wire of an inserted end of a cable (not shown).

In assembly of the electrical connector 10, the terminals 16 are each inserted from the rear of the housing 12, and received in a corresponding passage 12b of the housing 12. The soldering portions 16c are exposed outside of the housing 12, for being soldered onto corresponding wires of the inserted end of the cable.

In order to enhance engagement between the terminals 16 of the electrical connector 10 and the inserted end of the cable, an insert molding process is provided to integrally mold the rear of the housing 12 and the inserted end of the cable. Engaging parts of the housing 12 and the inserted end of the cable are molded together to form a new integrated housing (not shown). Thus said engagement is strengthened and protected from environmental disturbance.

Before the insert molding process, it is necessary to block the passageways 12d and gaps (not labeled) between the terminals 16 and side walls of the passages 12b of the housing 12, in order to prevent molten material from entering the slot 12a and the passages 12b during the insert molding process. The sealing member 14 is provided to block said gaps, and the blocks 22 are provided to block the passageways 12d. Accordingly, an inside of the housing 12 is kept intact.

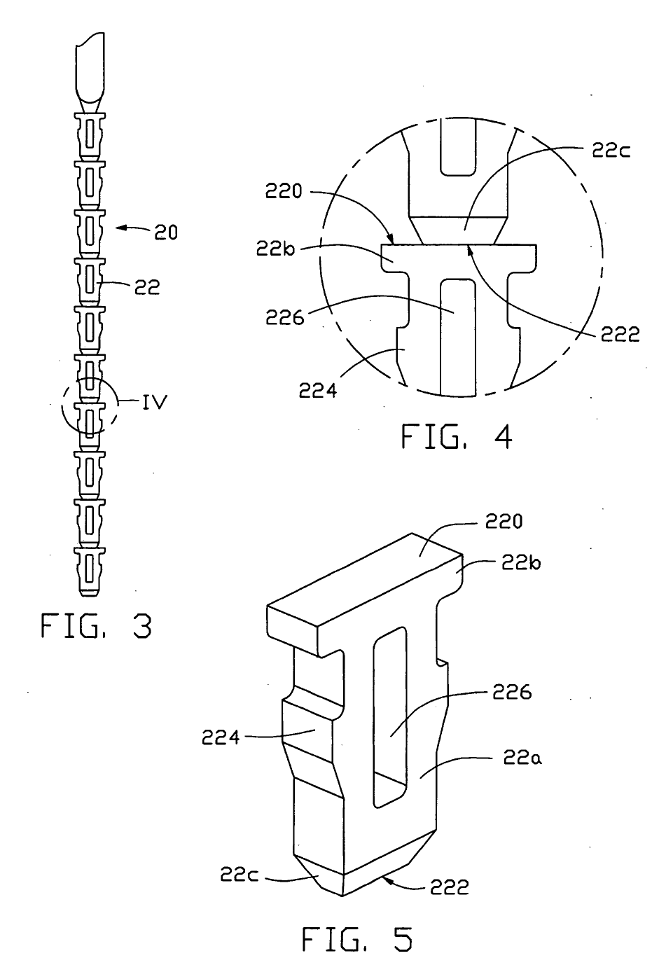

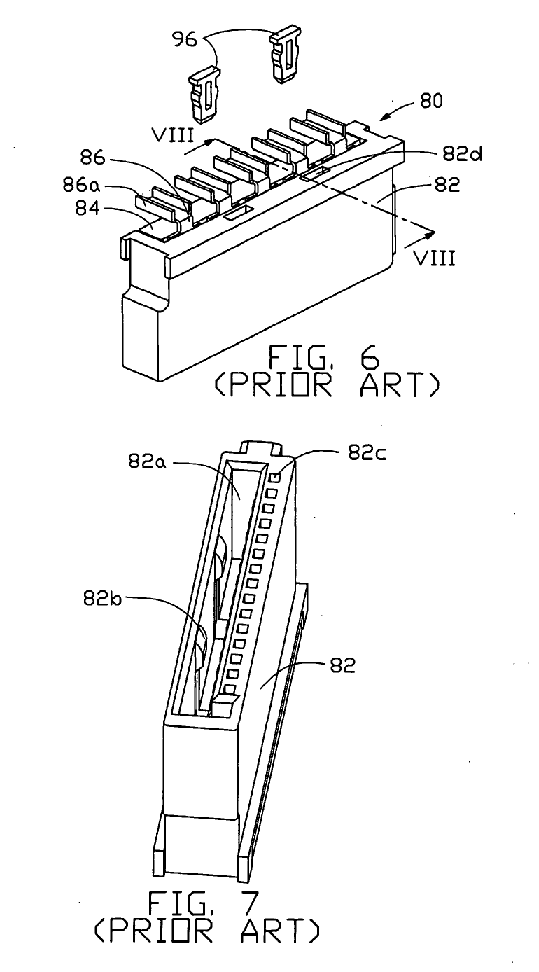

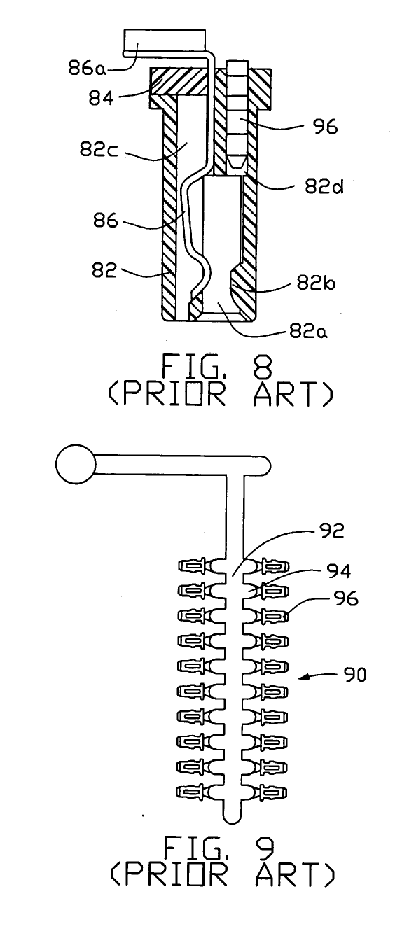

FIGS. 3, 4 and 5 respectively show an elongate block strip 20, and a single block 22 broken off from the block strip 20. The block strip 20 comprises a plurality of the blocks 22 successively joined end-to-end along a common longitudinal axis thereof. Each block 22 has a substantially rectangular body 22a, with an enlarged rear end 22b and a tapered front end 22c. A transverse end surface 220 is defined on a rear of the rear end 22b. An area of the end surface 220 is substantially larger than an area of a mouth of either passageway 12d. A front end surface 222 is defined on a front of the front end 22c, the end surface 222 being parallel to the end surface 220 of the rear end 22b. However, the end surface 220 of the rear end 22b is substantially larger than the end surface 222 of the front end 22c. The front end 22c of one block 22 integrally adjoins the rear end 22b of an adjacent block 22, the blocks 22 thereby collectively forming the block strip 20. With this configuration, successive blocks 22 of the block strip 20 can be used one by one as needed. Every part of the block strip 20 is used, thereby reducing the cost of materials.

In addition, in use, rear blocks 22 of the block strip 20 can be held to facilitate insertion of a frontmost block 22 into a corresponding passageway 12d of the housing 12. Insertion of the blocks 22 into the passageways 12d is thus speedy and efficient. Furthermore, because the end surface 220 of the rear end 22b of each block 22 adjoins the substantially smaller end surface 222 of the front end 22c of the adjacent block 22, each block 22 is easily and safely broken off from the block strip 20. This further facilitates speedy and efficient insertion of the blocks 22.

A pair of barbs 224 is formed on opposite lateral sides of the body 22a of each block 22 respectively. The body 22a defines a vertical aperture 226 in a middle thereof. During insertion of the block 22 into a corresponding passageway 12d of the housing 12, the aperture 226 provides space to allow deformation of opposite side portions of the body 22a. Thus the barbs 224 can interferingly engage in the passageway 12d. The rear end 22b of the block 22 covers and seals the mouth of the passageway 12d. The blocks 22 thereby prevent molten material from entering the housing 12 via the passageways 12b.

It should be understood that the shape of the blocks 22 may be varied. Alternative shapes can be configured for the blocks 22, depending among other things on the particular structure of the passageways 12d of the housing 12 being produced.

Furthermore, although the present invention has been described with reference to a particular embodiment, it is not to be construed as being limited thereto. Various alterations and modifications can be made to the embodiment without in any way departing from the scope or spirit of the present invention as defined in the appended claims.

What is claimed is:

1. A block strip comprising:
a plurality of blocks each having a body with a front end and a rear end, the front end of one block joining the rear end of a next block to successively join said plurality of blocks together along the longitudinal direction of the block strip.

2. The block strip of claim 1, wherein the front end has a tapered configuration with an end surface.

3. The block strip of claim 2, wherein the rear end has a transverse end surface parallel to the end surface of the front end.

4. The block strip of claim 3, wherein an area of the end surface of the rear end is larger than that of the end surface of the front end.

5. The block strip of claim 4, wherein the body defines upper and lower major surfaces.

6. The block strip of claim 5, wherein the body defines a slot between the upper and lower major surfaces thereof.

7. The block strip of claim 6, wherein the body forms at least one barb at one side thereof.

8. An elongate strip for making blocks that are adapted to be incorporated in an electrical connector having a dielectric housing with at least one passageway, the strip comprising:
a plurality of strip blocks each being adapted for being inserted into a corresponding passageway of the housing, the strip blocks being jointed end-to-end along the longitudinal direction of the strip.

9. The strip of claim 8, wherein each of the strip blocks has a body with a front end and a rear end.

10. The strip of claim 9, wherein the front end of one strip block integrally joins the rear end of a next strip block.

11. The strip of claim 10, wherein the front end has a tapered configuration with an end surface.

12. The strip of claim 1, wherein the rear end has an end surface parallel to the end surface of the font end thereof.

13. The strip of claim 12, wherein an area of the end surface of the rear end is larger than that of the end surface of the front end.

14. The strip of claim 13, wherein the body defines upper and lower major surfaces.

15. The strip of claim 14, wherein the body defines a slot between the upper and lower major surfaces thereof.

16. The strip of claim 15, wherein the body forms at least one barb at one side thereof.

17. A method of making an electrical connector, comprising:
providing an insulative housing with a plurality of passageways therein;
providing at least one access passageways in communication with the passageways to form at least one protrusion in at least one passageway;
inserting the contacts into the corresponding passageways, respectively;
providing a series of blocks in one strip and inserting one block into the access passageway to further occupy said access passageway for rearwardly blocking said passageway from exterior via said access passageway;
breaking said inserted one block from the strip;
applying a sealing member to the housing to blocking said passageways from directly rearwardly communicating the exterior; and
overmolding said housing.
